(19) United States
(12) Patent Application Publication
(10) Pub. No.: US 2022/0035960 A1
(43) Pub. Date: Feb. 3, 2022

(54) Design Generation Method For Watch Part, Design Generation System For Watch Part, Server And Output Terminal

(71) Applicant: Seiko Epson Corporation, Tokyo (JP)

(72) Inventors: Kazunori HOSHINO, Matsumoto (JP); Hironori HASEI, Azumino (JP); Shogo KOBAYASHI, Shiojiri (JP)

(21) Appl. No.: 17/385,986

(22) Filed: Jul. 27, 2021

(30) Foreign Application Priority Data
Jul. 28, 2020 (JP) 2020-127455

(51) Int. Cl. G06F 30/10; G04B 19/10

(52) U.S. Cl. CPC G06F 30/10; G06F 2111/02; G04B 19/10

(57) ABSTRACT

A design generation method for a watch part includes the steps of: by an output terminal, transmitting, to a server, watch model information selected by a user and event data including at least a date/time entered by the user; by the server, generating, based on the model information received by the server, model data being component information of the watch part; by the server, generating, based on the event data received by the server, unique data and feature data that are a design element of the watch part; by the server, transmitting, to the output terminal, the model data, the unique data, and the feature data; and by the output terminal, displaying the model data, the unique data, and the feature data on a display unit of the output terminal.

The present application is based on, and claims priority from JP Application Serial Number 2020-127455, filed Jul. 28, 2020, the disclosure of which is hereby incorporated by reference herein in its entirety.

### BACKGROUND

### 1. Technical Field

The present disclosure relates to a design generation method for a watch part, a design generation system for a watch part, a server and an output terminal.

### 2. Related Art

In addition to practicality of checking the time, a watch also has an aspect of a favorite item of a user. For this reason, a watch capable of imparting custom-made decoratability is known (see, for example, Japanese Patent No. 6569929).

The watch of Japanese Patent No. 6569929 has a link that can be fitted into a concave portion provided in a windshield. The link includes a profile that does not inhibit visibility of a time displayed by a long hand and a short hand via the windshield, and has a decorative surface portion in a visible range.

Since the link needs to be fit into the windshield in the watch, the degree of freedom of applicable design is greatly limited.

### SUMMARY

A design generation method for a watch part of the present disclosure includes the steps of: by an output terminal, transmitting, to a server, watch model information selected by a user and event data including at least a date/time entered by the user; by the server, generating, based on the model information received by the server, model data being component information of the watch part; by the server, generating, based on the event data received by the server, unique data and feature data that are a design element of the watch part; by the server, transmitting, to the output terminal, the model data, the unique data, and the feature data; and by the output terminal, displaying the model data, the unique data, and the feature data on a display unit of the output terminal.

A design generation system for a watch part of the present disclosure includes an output terminal and a server communicating via a network, wherein the output terminal is configured to transmit, to the server, watch model information selected by a user and event data entered by the user, and display, on a display unit, model data, unique data, and feature data that are received from the server, and the server is configured to generate, based on the model information received by the server, model data being component information of the watch part, generate the unique data and the feature data based on the event data received by the server, and transmit the model data, the unique data, and the feature data to the output terminal.

A server of the present disclosure includes a communication unit configured to communicate with an output terminal via a network, and a processing unit configured to generate model data being component information of a watch part, based on watch model information received from the output terminal, generate unique data and feature data based on event data received from the output terminal, and transmit the model data, the unique data, and the feature data to the output terminal.

An output terminal of the present disclosure includes a communication unit configured to communicate with a server via a network, and an operating unit operated by a user, a display unit, and a processing unit, the processing unit being configured to transmit, to the server, watch model information selected by a user using the operating unit, and event data entered by the user using the operating unit, and display, on the display unit, model data, unique data, and feature data that are received from the server.

### BRIEF DESCRIPTION OF THE DRAWINGS

FIG. 1 is a block diagram illustrating a design generation system of an exemplary embodiment.

FIG. 2 is a sequence diagram illustrating operation of the design generation system of the exemplary embodiment.

FIG. 3 is a flowchart illustrating a data generation process of the exemplary embodiment.

FIG. 4 is a flowchart illustrating an editing process of the exemplary embodiment.

FIG. 5 is a flowchart illustrating emphasis processing of the exemplary embodiment.

FIG. 6 is a flowchart illustrating overlap correction processing of the exemplary embodiment.

FIG. 7 is a flowchart illustrating the overlap correction processing of the exemplary embodiment.

FIG. 8 is a flowchart illustrating a data adjustment process of the exemplary embodiment.

FIG. 9 is a diagram illustrating an example design generation process of a watch part of the exemplary embodiment.

### DESCRIPTION OF EXEMPLARY EMBODIMENTS

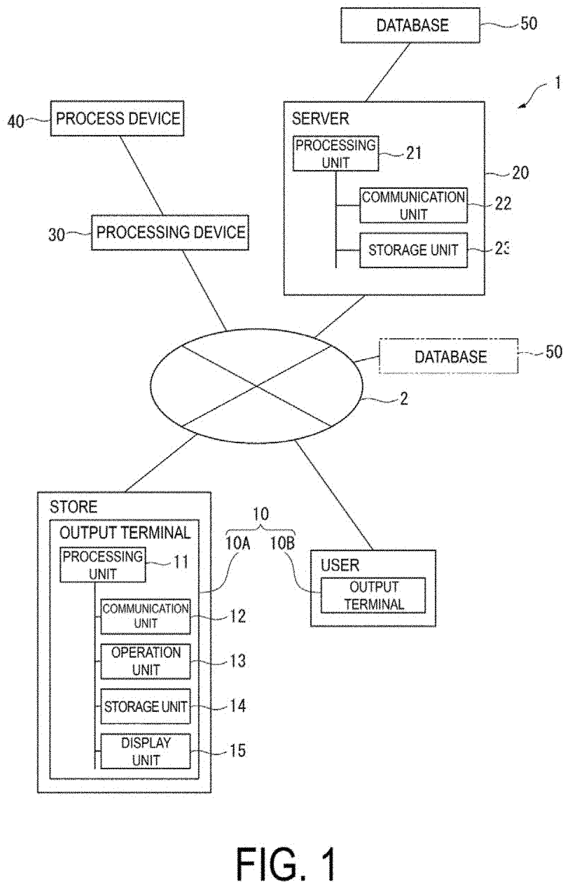

Hereinafter, a design generation system 1 for a watch part of the present exemplary embodiment will be described. FIG. 1 is a diagram illustrating a configuration of the design generation system 1 in which a user can design and order an original watch, in particular, a dial. The design generation system 1 includes an output terminal 10 that outputs order information, and a server 20 that manages the order information. The output terminal 10 includes an output terminal 10A for a store constituted by a personal computer, a tablet, etc. provided in the store for selling a watch, and an output terminal 10B for a user constituted by a personal computer, a smartphone, etc. owned by each user.

The output terminal 10A and the output terminal 10B are configured to communicate with the server 20 via a network 2 such as the Internet.

The server 20 is configured to communicate with a processing device 30 via the network 2. The processing device 30 converts data for processing a dial into data that can be read by a process device 40, and transmits the data to the process device 40. Note that the server 20 as well as the processing device 30 and the process device 40 may be installed in the same facility, and the processing device 30 may be configured to communicate with the server 20 via a LAN (Local Area Network).

Further, the processing device 30 may be eliminated by providing the server 20 with data conversion function of the processing device 30, and configuring the server 20 to directly transmit the process data to the process device 40.

Furthermore, the process device 40 may include a function of the processing device 30, and may be configured to convert the data transmitted from the server 20 into the process data in the process device 40.

Configuration of Output Terminal

For configurations of the output terminals 10A and 10B, the output terminal 10A provided in the store will be described as an example. The output terminal 10A includes a processing unit 11, a communication unit 12, an operating unit 13, a storage unit 14, and a display unit 15.

The processing unit 11 is configured by a CPU (Central Processing Unit) and executes an application stored in the storage unit 14 to execute processing for generating a design of the dial.

The communication unit 12 couples the output terminal 10A to the network 2 and communicates with the server 20 via the network 2.

The operating unit 13 generates and transmits an operation signal to the processing unit 11 in accordance with operation of an operator of the output terminal 10A via a keyboard, a mouse, a touch panel, etc.

The storage unit 14 stores data necessary to execute the application or design generation processing of the dial.

The display unit 15 is a display etc. that displays information necessary for the design generation processing of the dial.

The output terminal 10B has a configuration similar to that of the output terminal 10A.

Server Configuration

The server 20 includes a processing unit 21, a communication unit 22, and a storage unit 23.

The processing unit 21 is configured by a CPU, and executes a server application stored in the storage unit 23 to execute the design generation processing on the dial.

The communication unit 22 couples the server 20 to the network 2 and communicates with the output terminals 10A and 10B via the network 2.

The storage unit 23 stores data necessary to execute the server application or the design generation processing on the dial.

A database 50 is coupled to the server 20. The database 50 stores astronomical data. In the design generation system 1 according to the present exemplary embodiment, a constellation, a star map, etc. is processed and displayed on the dial that is a watch part, and the database 50 stores the necessary astronomical data for these processing displays. Note that the database 50 is not limited to being directly coupled to the server 20, and may be coupled to the server 20 via the network 2.

Ordering Method for Watch Part

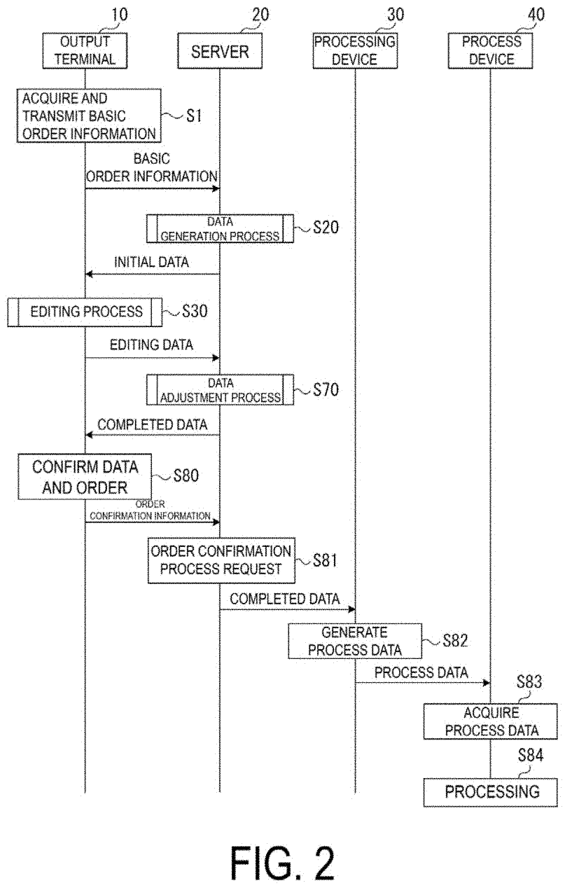

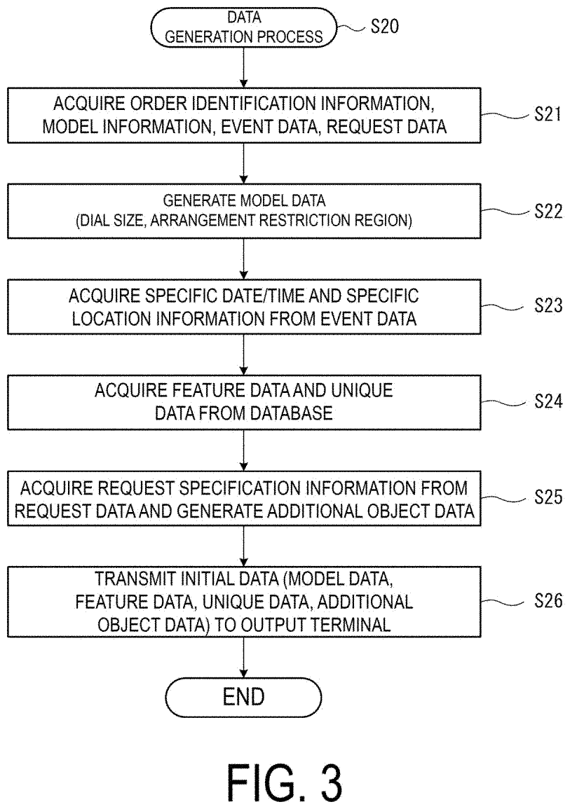

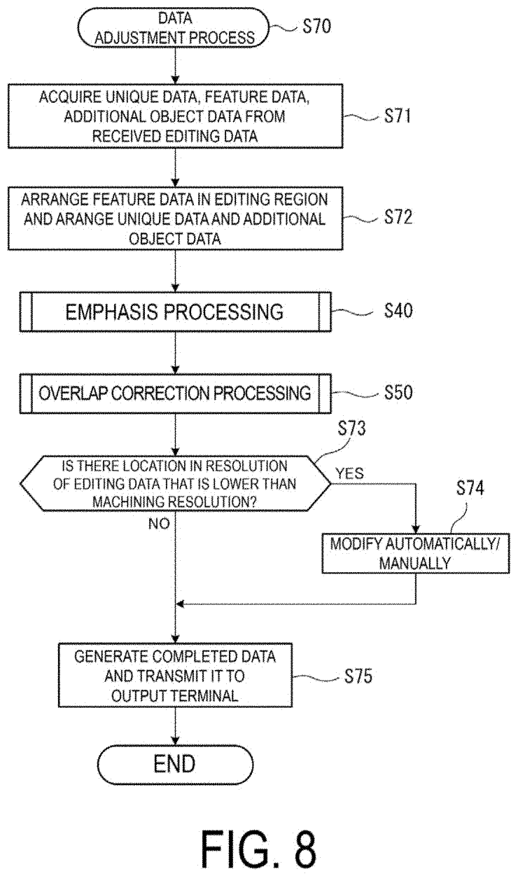

Next, a method for customizing the dial that is a watch part using the design generation system 1 will be described with reference to a sequence diagram of FIG. 2 and flowcharts of FIGS. 3-8.

First, the output terminal 10 executes step S1 to acquire basic order information and transmits it to the server 20. The basic order information includes order identification information, model information, event data, request data.

The order identification information is information identifying an order entered to the output terminal 10, and a so-called ID (identification).

The model information is a model number of a base model of the watch. The output terminal 10 displays images, etc. of the base model of the watch side-by-side in the display unit 15, and acquires the model number of the base model selected by the user in the operating unit 13 as the model information. Further, the output terminal 10 may display, on the display unit 15, information of the base model stored in the storage unit 14 of the output terminal 10, or may load the information of the base model stored in the storage unit 23 of the server 20 and display the information in the display unit 15. In a case where the base model information is loaded from the storage unit 23 of the server 20, the most recent base model information can be always loaded and displayed on the display unit 15. In a case where the base model information is loaded from the storage unit 14 of the output terminal 10, communication with the server 20 can be omitted, whereby the base model information can be quickly displayed on the display unit 15. Furthermore, the base model information can be displayed on the display unit 15 even in an environment in which the server 20 cannot communicate. In this case, the information of the base model stored in the storage unit 14 may be periodically received from the server 20 and updated.

The event data includes a particular date/time that the user enters, a type indicating the content of the date/time, and specific location information. The type indicates a meaning of the date/time, and is information indicating a type such as, for example, a birthday, a wedding anniversary, etc. The specific location information may include latitude and longitude, or may include a local name or time zone, and may be information that can identify a star map or an observation of a constellation used as a design of the dial, as described below.

Note that the user may designate a particular constellation or star individually, in which case the event data includes these designated information.

The request data is data that includes request specification information that is customization information selected by the user and added to the base model of the watch. Specifically, the request data is information of customizable items, such as, of the base model of the dial, a color, a pattern, a type and number of jewelry, a flow star, a symbol indicating a satellite, etc., a star map, an auxiliary line connecting the stars that constitute the constellation. The user can generate the request specification information in which the presence or absence or the type of these customizable items have been entered at the output terminal 10, and transmit the request specification information as the request data to the server 20.

Data Generation Process

Upon receiving the transmission from the output terminal 10 in the communication unit 22, the processing unit 21 of the server 20 executes step S20, which is a data generation process.

The data generation process of step S20 executed in the processing unit 21 will be described with reference to the flowchart of FIG. 3.

Upon receiving the basic order information transmitted from the output terminal 10, the processing unit 21 executes step S21 to acquire the order identification information, the model information, the event data, and the request data included in the basic order information.

Next, the processing unit 21 executes step S22 to acquire and generate model data of the watch corresponding to the acquired model information from the storage unit 23. In other words, the storage unit 23 stores a plurality of model data of the watch, specifically, data relating to physical feature and configurations such as, the dial, which is a watch part, and profile data of a plurality of components that constitute a watch, such as an hour hand, a minute hand, and a second hand. The profile data of the dial are data specifying the size and shape of the dial. Furthermore, the data of the dial includes a profile of a component of the dial, an arrangement restriction region, a material, a foundation pattern, etc. The component of the dial is an element provided at the dial, such as a scale, a logo, a day window, and a through hole for a hand shaft provided at the dial. Further, the arrangement restriction region is a region that restricts the provision of other design elements in a position overlapping the foregoing component.

Thus, in step S22, the processing unit 21 acquires a dial size, the arrangement restriction region, etc. from the storage unit 23, and generates the model data.

Next, the processing unit 21 executes step S23 to acquire a specific date/time and specific location information from the event data.

Next, the processing unit 21 executes step S24 to acquire the feature data and the unique data from the database 50 based on the acquired specific date/time and specific location information.

The feature data, in the present exemplary embodiment, is star map data identified by the specific date/time and the specific location information. That is, the database 50 stores the astronomical data, and further when the processing unit 21 designates the date/time and location to retrieve the astronomical data, the database 50 can acquire the star map data as the feature data that can be seen at that date/time and location. This feature data is a design element of the dial that is a watch part, and is used as a background of the unique data in the present exemplary embodiment.

This star map data is constituted by a plurality of elements corresponding to stars, may be a whole top star map, an orientation-limited star map, or only a portion thereof, e.g., only around the North Star. The star to be displayed may also be selected by a grade. For example, only a bright star of fifth grade or greater may be selected and displayed.

The unique data is a design element of the dial, and is the astronomical data associated with the particular date/time (e.g., the constellation data corresponding to the birthday) in the present exemplary embodiment. Further, when the event data includes the designated information designating the star or constellation designated by the user, the data of the designated star or constellation may be the unique data.

Next, the processing unit 21 executes step S25 to acquire the request specification information from the request data, and generates additional object data corresponding to each component of the request specification information.

Next, the processing unit 21 of the server 20 executes the step S26 to transmit, to the output terminal 10, initial data including the model data, the feature data, the unique data, and the additional object data. The processing unit 21 typically configures the model data, the feature data, the unique data, and the additional object data to different layers, and transmits the initial data in a state in which each layer is overlaid. Note that the processing unit 21 may transmit the initial data in a state where the model data, the feature data, the unique data, and the additional object data are not overlaid, but are separated individually.

Editing Process

Upon receiving the transmission from the server 20 in the communication unit 12, the processing unit 11 of the output terminal 10 executes the step S30, which is an editing process. The editing process is a process of editing the initial data generated at the server 20 while the user confirms the initial data.

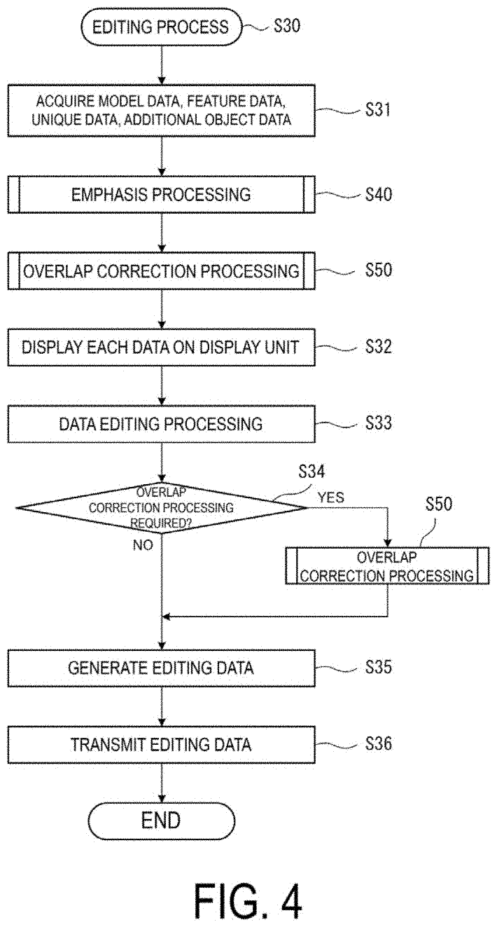

The editing process of step S30 executed in the processing unit 11 will be described with reference to the flowchart of FIG. 4.

Upon receiving the initial data transmitted from the server 20, the processing unit 11 executes step S31 to acquire the model data, the feature data, the unique data, and the additional object data included in the initial data.

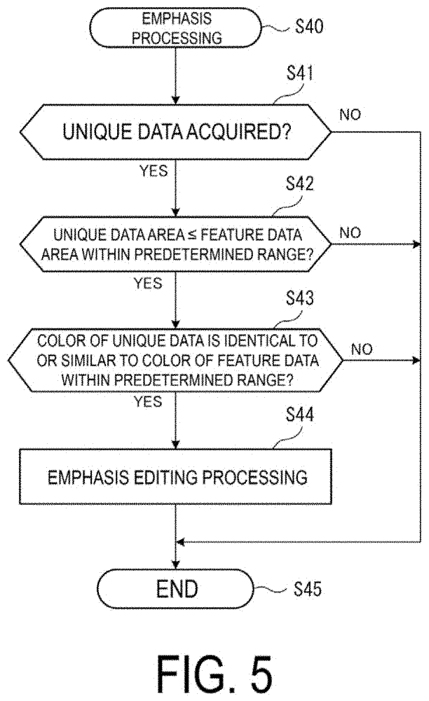

Emphasis Processing Next, the processing unit 11 executes emphasis processing of step S40. The event data or the unique data selected by the user's designation is an important element for the user to customize the dial, that is, a primary design element in the dial. Therefore, in order to emphasize the unique data of the constellation of the birthday, the constellation or star designated by the user over other elements, the processing unit 11 executes the emphasis processing illustrated in FIG. 5.

The processing unit 11 executes step S41 to determine whether the unique data has been acquired. When the processing unit 11 determines NO in step S41, the processing unit 11 proceeds to step S45, and terminates the emphasis processing. This is because, when the unique data is not included, it is not necessary to emphasize the unique data.

When the processing unit 11 determines YES in step S41, the processing unit 11 executes step S42 to compare an area in plan view on the dial and determines whether an area of the unique data is less than or equal to an area of the feature data within a predetermined range. The predetermined range is a predetermined range surrounding the unique data and is a range that affects confirmation of the unique data.

When the processing unit 11 determines NO in step S42, the processing unit 11 proceeds to step S45, and terminates the emphasis processing. This is because, when the area of the unique data is greater than the area of the feature data surrounding the unique data, the unique data can be confirmed without emphasizing on the unique data.

When the processing unit 11 determines YES in step S42, the processing unit 11 executes step S43 to determine whether a color of the unique data is the same as or similar to a color of the feature data within a predetermined range. Here, the same color indicates that the three attributes of color (hue, saturation, and lightness) are the same. Further, the similar color indicates a case where at least one of the hue, saturation, and lightness is different, but the both colors are difficult to be distinguished when viewed by a person. Note that the range in which the colors are similar can be set in advance.

When the processing unit 11 determines NO in step S43, the processing unit 11 proceeds to step S45, and terminates the emphasis processing. This is because, when the color of the unique data is different from color of the feature data to a degree that it is not similar to the color of the feature data, the unique data and the feature data can be distinguished by a color difference, and the unique data can be confirmed without emphasizing the unique data.

When the processing unit 11 determines YES in step S43, the processing unit 11 executes step S44 to perform emphasis editing processing. The emphasis editing processing is a process that changes an area such that the area of the unique data is larger than the feature data within the predetermined range, or changes a color such that the color of the unique data is not similar to the color of the feature data within the predetermined range. Note that in the emphasis editing processing, both the area and the color may be changed, or only one of the area and the color may be changed. For example, the star grade and size may be linked, and the bright star may have the brighter lightness and also have the greater size of the star.

Furthermore, in the case where the color is changed, it is sufficient to change the unique data so that the unique data can be visually distinguished from the feature data, and any one or a plurality of the elements of the hue, the lightness, and the saturation may be changed.

Note that when the processing unit 11 determines NO in step S43, the processing unit 11 may confirm whether the color change is necessary for the user, and may execute step S44 in a case where the user instructs that the color change is needed. Furthermore, the processing unit 11 may change the shape of the unique data or the feature data in the emphasis editing processing of step S44.

Furthermore, the processing unit 11 automatically performs editing based on a preset editing rule in the emphasis editing processing of step S44, while the processing unit 11 may be configured to allow the user to operate the operating unit 13 to manually edit the unique data and the feature data displayed on the display unit 15. Furthermore, the result automatically edited by the processing unit 11 may be manually fine-tuned by the user.

When the processing unit 11 moves to step S45 and terminates the emphasis processing in step S40, the processing unit 11 returns to the editing process illustrated in FIG. 4.

Overlap Correction Processing

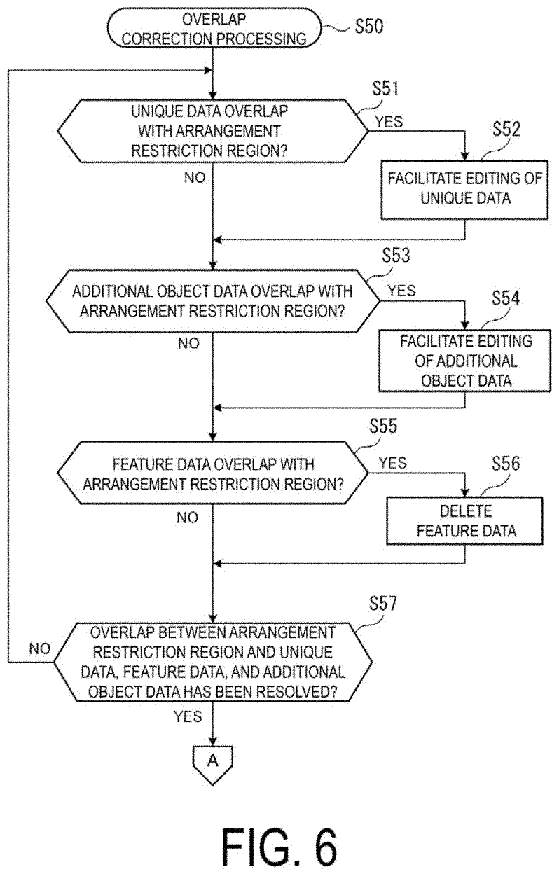

Next, as illustrated in FIG. 6, the processing unit 11 executes overlap correction processing in step S50. The processing unit 11 sequentially determines whether the unique data, the additional object data, and the feature data overlap in the arrangement restriction region. The arrangement restriction region is a region in which the scale, the logo, the day window, or the through hole of the dial is provided. Other design elements such as the unique data cannot be arranged at the region, therefore, the presence or absence of overlap with the arrangement restriction region needs to be determined. Furthermore, when determining the presence or absence of overlap with the arrangement restriction region, the determination may be made taking into consideration not only a flat surface region, but also a height region. For example, when an object protruding from the dial such as jewelry is arranged at the dial, the determination is made in consideration of interference with a hand, etc.

The processing unit 11 executes step S51 to determine whether the unique data overlaps with the arrangement restriction region.

When the processing unit 11 determines YES in step S51, the processing unit 11 executes step S52 to facilitate editing of the unique data. For example, some or all display aspects of the unique data are changed to facilitate the user for editing. The display aspect may be changed as long as it can notify the user that the unique data needs to be edited, for example, by changing the color of the unique data or flashing.

In step S52, the processing unit 11 moves and edits the unique data in a case where the user operates the operating unit 13 to instruct the correction of the unique data, for example, the movement from the arrangement restriction region.

In a case where after the processing of step S52 or the processing unit 11 determines NO in step S51, the processing unit 11 executes step S53 to determine whether the additional object data overlaps with the arrangement restriction region.

When the processing unit 11 determines YES in step S53, the processing unit 11 executes step S54 to facilitate editing of the additional object data. The method of facilitating editing of the additional object data is similar to the method of facilitating the editing of the unique data of step S52.

In step S54, the processing unit 11 moves and edits the additional object data in a case that the user operates the operating unit 13 to instruct the correction of the additional object data, for example, the movement from the arrangement restriction region.

In a case where after the processing of step S54 or the processing unit 11 determines NO in step S53, the processing unit 11 executes step S55 to determine whether the feature data overlaps with the arrangement restriction region.

When the processing unit 11 determines YES in step S55, the processing unit 11 executes step S56 to delete the feature data. This is because the feature data is a design element that is the background of the unique data, and does not have a substantial effect on the design of the dial, even when the element thereof overlapping the arrangement restriction region is deleted.

In a case where after the processing of step S56 or the processing unit 11 determines NO in step S55, the processing unit 11 executes step S57 to determine whether the overlap between the arrangement restriction region and the unique data, the additional object data, and the feature data has been resolved. In a case where the overlap with the arrangement restriction region has not been resolved even when the processing of the steps S52, S54, S56 is executed, for example, in a case where the moved unique data and the moved additional object data overlap with another arrangement restriction region, the processing unit 11 determines NO in step S57 and repeats steps S51 to S57 again.

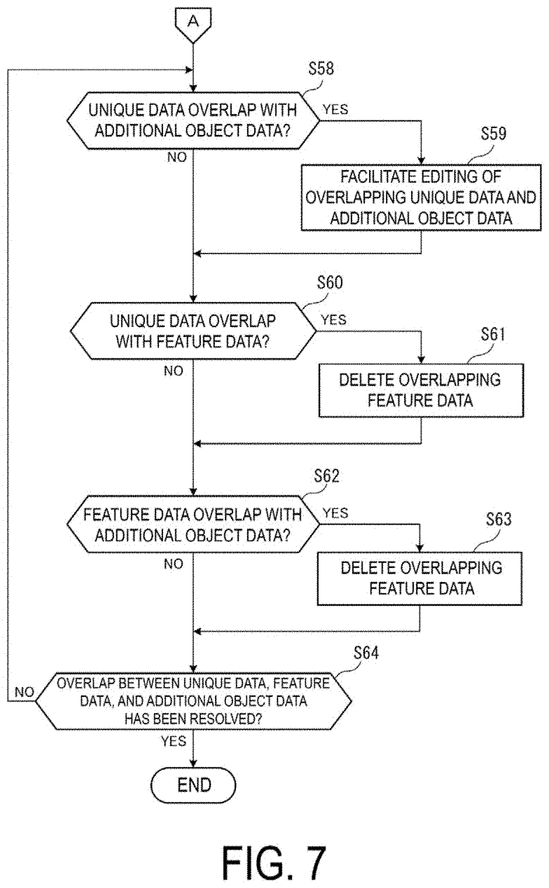

When the processing unit 11 determines YES in step S57, the processing unit 11 executes step S58 illustrated in FIG. 7 to determine whether the unique data overlaps with the additional object data.

When the processing unit 11 determines YES in step S58, the processing unit 11 executes step S59 to facilitate editing of the overlapping unique data and the additional object data. The method of facilitating editing of the unique data and the additional object data is a method of changing each display aspect in a manner similar to the method of facilitating editing of the unique data of step S52.

In a case where after the processing of step S59 or the processing unit 11 determines NO in step S58, the processing unit 11 executes step S60 to determine whether the unique data overlaps with the feature data.

When the processing unit 11 determines YES in step S60, the processing unit 11 executes step S61 to delete the overlapping feature data. For example, when the constellation stars that are the unique data overlap with the constellation line connecting the constellation stars that are the additional object data, the region of the constellation line that overlaps with the constellation stars is deleted.

In a case where after the processing of step S61 or the processing unit 11 determines NO in step S60, the processing unit 11 executes step S62 to determine whether the feature data overlaps with the additional object data.

When the processing unit 11 determines YES in step S62, the processing unit 11 executes step S63 to delete the overlapping feature data.

In a case where after the processing of step S63 or the processing unit 11 determines NO in step S62, the processing unit 11 executes step S64 to determine whether the overlap between the unique data, the feature data, and the additional object data has been resolved. When the processing unit 11 determines NO in step S64, the processing unit 11 repeats steps S58 to S64 again.

On the other hand, when the processing unit 11 determines YES in step S64, the processing unit 11 terminates the overlap correction processing and returns to the editing process in FIG. 4.

After executing steps S40 and S50, the processing unit 11 executes step S32 to display each of the data in the display unit 15. As a result, the display unit 15 displays the design of the dial that has been subjected to the emphasis processing and the overlap correction processing.

Next, the processing unit 11 executes step S33 to perform the data editing processing. In the data editing processing, various editing processing can be executed on the design of the dial displayed on the display unit 15 while the user operates the operating unit 13. For example, the data editing processing allows for changing the color, shape, and size of an element of the unique data and the additional object data, changes an element of the feature data similarly, and deletes the element of the feature data. Note that when the user determines that the data editing processing is unnecessary, the user may terminate the data editing processing without editing.

Next, the processing unit 11 executes step S34 to determine, as a result of the data editing processing of step S33, whether the overlap correction processing is necessary again. For example, when performing the data editing processing, in a case where the position of the additional object data is edited and then overlaps with another element, the processing unit 11 determines that the overlap correction processing is necessary, and determines YES in step S34.

When the processing unit 11 determines YES in step S34, the processing unit 11 again executes the overlap correction processing in step S50.

After the step S50 is executed again or, alternatively, in a case where the processing unit 11 determines NO in step S34, the processing unit 11 executes step S35 to generate the editing data. The editing data is data in which the model data, the feature data, the unique data, and the additional object data are combined. Next, the processing unit 11 executes the step S36, transmits the generated editing data to the server 20, and terminates the editing process.

Data Adjustment Process

As illustrated in FIG. 2, when receiving the editing data transmitted from the output terminal 10 in the communication unit 22, the processing unit 21 of the server 20 executes step S70, which is a data adjustment process. The data adjustment process of step S70 adjusts the editing data edited by the user in consideration of constraints on the machining accuracy of the process device 40 etc. in order to make the editing data available by the actual process device 40.

The processing unit 21 executes step S71 to acquire the unique data, the feature data, and the additional object data from the received editing data.

Next, the processing unit 21 executes step S72 to arrange the acquired feature data in the editing region for dial processing, and further arranges the unique data and the additional object data in the editing region. Note that each of the data is arranged in the editing region based on the edited state in the editing process in step S30.

Next, the processing unit 21 executes the emphasis processing in step S40 and the overlap correction processing in step S50. Note that each processing may be performed automatically by the processing unit 21 of the server 20, or may be performed manually by a professional operator via the server 20.

Next, the processing unit 21 executes step S73 to determine whether there is a location in resolution of the editing data that is lower than the machining resolution of the process device 40.

When the processing unit 21 determines YES in step S73, the processing unit 21 executes step S74 to automatically modify the resolution. Alternatively, the professional operator manually modifies the resolution.

In a case where the processing unit 21 determines NO after the execution of step S74 or in step S73, the processing unit 21 executes step S75 to generate the completed data and transmits the generated data to the output terminal 10. Then, the processing unit 21 terminates the data adjustment process.

Next, as illustrated in FIG. 2, upon receiving the completed data, the output terminal 10 displays the completed data on the display unit 15. Then, when the user confirms the completed data and performs the ordering operation, the processing unit 11 executes step S80 to transmit order confirmation information to the server 20.

The processing unit 21 of the server 20 receives the order confirmation information transmitted from the output terminal 10. Then the processing unit 21 executes step S81, confirms the order, and transmits the completed data to the processing device 30 to execute process request processing.

Upon receiving the completed data transmitted from the server 20, the processing device 30 executes step S82, converts the completed data, generates the process data to be used for processing in the process device 40, and transmits the data to the process device 40.

The process device 40 executes step S83 to acquire the process data transmitted from the processing device. Then, the process device 40 executes step S84 to process the dial using the acquired process data.

Note that a processing method of the dial in the process device 40 can be appropriately selected according to the material of the dial and the processing contents. The process device 40 processes the dial by laser processing and plating, for example. In other words, after the surface of the dial is formed by laser processing and the surface is subjected to plating treatment, a color resin or a clear resin is used to coat the surface of the dial. Thereafter, the convex portion of the surface of the dial is polished and plated at the polished convex surface. This allows the unique data (e.g., a star of a constellation), the additional object data (e.g., a constellation line), and the feature data (e.g., a star a star map data in which the grade of the star is greater than or equal to a predetermined grade) to be processed as convex portions on the dial, and the convex surfaces are plated, whereby the constellation portion and the star portion can be displayed with a shiny glow.

The dial processed by the process device 40 is incorporated into a watch of the model data selected by the user and delivered to a user-ordered store or a user designated delivery destination.

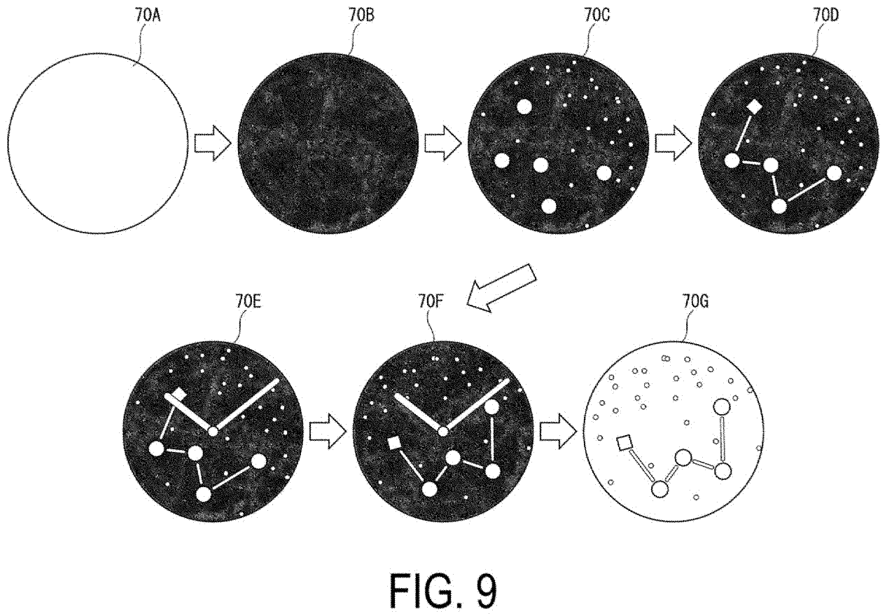

FIG. 9 is a diagram illustrating an example design generation process of the dial that is a watch part according to the present exemplary embodiment. A dial 70A is a model selected by the user, where a planar circular dial 70A is selected. A dial 70B is a base design indicating a color or pattern of the dial selected by the user. In a dial 70C, stars included in the star map based on the feature data and stars of the constellation based on the unique data are arranged.

In a dial 70D, the constellation line, which is the additional object data, is added, and a shape of one of the stars connected by the constellation line is changed. A dial 70E is configured with watch parts such as an hour hand or a minute hand. This dial 70E is an example of the initial data output in the data generation process of step S20.

A dial 70 F is an example of the editing data for which the design has been adjusted in the editing process of step S30, and specifically, is an example in which the positions of the constellation and the stars are adjusted.

A dial 70G is an example of the process data generated by the processing device 30 when the dial 70F is used as the completed data.

Effect of Present Exemplary Embodiment According to the present exemplary embodiment, the watch part can be designed with the unique data and the feature data generated based on the event data entered by the user, whereby the user can freely design the watch part with a user-customized design.

In particular, the watch part associated with various events can be designed since the date/time and location information designated by the user are transmitted as event data, and the unique data and the feature data are generated based on these date/time and location information. Thus, without being limited to the user's own watch, when using user's birthday and birthplace as the event data, or using places such as wedding anniversaries and weddings as the event data, the user can easily design the watch for a gift.

Since the additional object data is generated from the user's request data, and further the watch part is designed using the additional object data in addition to the unique data and feature data, a highly free design can be achieved based on the user's fine request.

In the editing process, the emphasis processing and the overlap correction processing are executed, whereby the design of the watch part can be adjusted automatically to a certain degree. Thus it is sufficient for the user to perform a minimum amount of editing, whereby it is possible to easily generate the design for the user.

Furthermore, since the emphasis processing and the overlap correction processing are executed, a design that emphasizes the unique data (i.e., a main design element) can be easily generated.

The data adjustment process is provided, whereby the complete data matching the machining resolution can be generated, and the process data that can accurately achieve the generated design can be generated.

### Other Exemplary Embodiments

Note that the present disclosure is not limited to the aforementioned exemplary embodiments described above, and variations, modifications, etc. within the scope in which the object of the present disclosure can be achieved are included in the present disclosure.

In the exemplary embodiment described above, the unique data includes the constellation and the star, but may include a building or a geographic feature. As the building, various buildings such as a castle, a temple, a dam, a bridge, a building-structure, etc. can be the unique data, while the geographic feature may be a mountain such as Mt. Fuji, and various so-called landmarks can be used as the unique data.

In the exemplary embodiment described above, the star map is used as the feature data, but it may be a landscape, a pattern, etc. In particular, it is preferable to utilize the feature data in accordance with the unique data.

In the exemplary embodiment described above, the emphasis processing and the overlap correction processing are executed in each of the editing process of step S30 and the data adjustment process in step S70, while the emphasis processing and the overlap correction processing may be executed only in one of the editing process and the data adjustment process.

In the exemplary embodiment described above, the unique data and the feature data are generated based on the date/time and location information of the event data, while the unique data and the feature data may be generated based on the location information alone. For example, in a case where a building is the unique data and the feature data is defined as a landscape, the unique data and the feature data can be generated with only the location information.

Furthermore, the event data may include information indicating the unique data and the feature data directly designated by the user.

Furthermore, the unique data, the feature data, and the additional object data are generated at the server 20, but may be generated by the output terminal 10.

In the exemplary embodiment described above, the editing process is executed by the output terminal 10, while a cloud-based design generation system may be configured such that the input operation is executed by the output terminal 10, the actual editing process (for example, the emphasis processing or the overlap correction processing) is executed at the server 20, and the editing result is displayed in real time on the display unit 15 of the output terminal 10.

The watch part that generates a design in the design generation system 1 is not limited to a dial, and a variety of watch parts, such as a hand, a case, a case back, and a main plate may be directed.

The model information and model data may be generated by the output terminal 10. In other words, when the model information and the model data are stored in the storage 14 of the output terminal 10 and the user selects the model information in the operating unit 13, the model data corresponding to the selected model information may be acquired from the storage unit 14 and generated. In this case, the basic order information transmitted from the output terminal 10 to the server 20 also includes the model data.

Summary of Present Disclosure A design generation method for a watch part of the present disclosure includes the steps of: by an output terminal, transmitting, to a server, watch model information selected by a user and event data including at least a date/time entered by the user; by the server, generating, based on the model information received by the server, model data being component information of the watch part; by the server, generating, based on the event data received by the server, unique data and feature data that are a design element of the watch part; by the server, transmitting, to the output terminal, the model data, the unique data, and the feature data; and by the output terminal, displaying the model data, the unique data, and the feature data on a display unit of the output terminal. According to the design generation method of the present disclosure, the watch part can be designed with the unique data and the feature data generated based on the event data entered by the user, whereby the user can freely design the watch part with a user-customized design.

In the design generation method for a watch part of the present disclosure, the unique data and the feature data each preferably include a plurality of elements, and when the element of the unique data overlaps the element of the feature data, the design generation method includes a step of deleting the overlapping element of the feature data by the output terminal or the server.

The overlapping feature data is deleted when the unique data and the feature data are arranged on the model data in an overlapping manner, whereby a design in which the unique data is prioritized can be generated automatically.

In the design generation method for a watch part of the present disclosure, the design generation method includes a step of emphasizing an element that constitutes the unique data over an element of the feature data by the output terminal or the server.

By emphasizing an element of the unique data when the unique data and the feature data are arranged in proximity, a design with the unique data noticeable can be generated automatically.

In the design generation method for a watch part of the present disclosure, the model data may include profile data for a plurality of components that constitute the watch.

The model data includes the profile data for the plurality of components that constitute the watch, e.g., a dial and a hand, whereby the model data may be designed to include the relationship with the profile of each component when designing by overlapping the unique data with the feature data.

In the design generation method for a watch part of the present disclosure, the model data preferably includes an arrangement restriction region configured to restrict an arrangement of the unique data and the feature data.

The model data includes the arrangement restriction region, whereby the unique data and the feature data can be prevented from being arranged in the arrangement restriction region, and in the watch part, the design can be performed in consideration of the area that cannot be actually arranged, and a design that is imagined of the finished product of the watch part can be generated.

In the design generation method for a watch part of the present disclosure, the event data may include a date/time and location information designated by the user.

The event data includes the date/time and location information designated by the user, whereby the unique data and the feature data can be generated based on these information, and the watch part with a user-specific design can easily design.

In the design generation method for a watch part of the present disclosure, the step of generating the unique data and the feature data preferably includes generating the unique data and the feature data by the server based on the date/time and the location information.

The server generates the unique data and the feature data based on the date/time and location information, whereby the watch part with a user-specific design can easily and automatically design.

In the design generation method for a watch part of the present disclosure, the unique data is preferably any of a constellation, a building, or a geographic feature.

The unique data of any of the constellation, the building, and the geographic feature can be designed at the watch part, whereby the watch part can be designed with the design specified by the user.

In the design generation method for a watch part of the present disclosure, the feature data is preferably any of a star map, a landscape, or a pattern.

The feature data of any of the star map, the landscape, or the pattern can be designed at the watch part, whereby, the watch part can be designed with a variety of designs in combination with the unique data.

In the design generation method for a watch part of the present disclosure, the method includes the steps of transmitting request data to the server by the output terminal, the request data instructing an additional design element of the watch part, generating additional object data by the server based on the request data, transmitting the additional object data to the output terminal by the server, and displaying the model data, the unique data, the feature data, and the additional object data on the display unit of the output terminal by the output terminal.

The watch part can be designed by adding the additional object data generated based on the request data, whereby a highly free design can be achieved based on the user's fine request.

A design generation system for a watch part of the present disclosure includes an output terminal and a server communicating via a network, wherein the output terminal is configured to transmit, to the server, watch model information selected by a user and event data entered by the user, and display, on a display unit, model data, unique data, and feature data received from the server, and the server is configured to generate model data based on the received model information, the model data being component information of the watch part, generate the unique data and the feature data based on the received event data, and transmit the model data, the unique data, and the feature data to the output terminal.

According to the design generation system of the present disclosure, the watch part can be designed with the unique data and the feature data generated based on the event data entered by the user, whereby the user can freely design the watch part with a user-customized design.

A server of the present disclosure includes a communication unit configured to communicate with an output terminal via a network, and a processing unit configured to generate model data based on watch model information received from the output terminal, the model data being component information of a watch part, generate unique data and feature data based on event data received from the output terminal, and transmit the model data, the unique data, and the feature data to the output terminal.

According to the server of the present disclosure, the watch part can be designed with the unique data and the feature data generated based on the event data received from an output terminal, whereby the user can freely design the watch part with a user-customized design.

An output terminal of the present disclosure includes a communication unit configured to communicate with a server via a network, and an operating unit operated by a user, a display unit, and a processing unit configured to transmit watch model information and event data to the server by the operating unit, the watch model information being selected by a user, the event data being entered by the user, and display, on the display unit, model data, unique data, and feature data received from the server.

According to the output terminal of the present disclosure, the watch part can be designed with the unique data and the feature data generated by transmitting the event data entered by the user to the server, whereby the user can freely design the watch part with a user-customized design.

What is claimed is:

1. A design generation method for a watch part, the method comprising:
by an output terminal, transmitting, to a server, watch model information selected by a user and event data including at least a date/time entered by the user;
by the server, generating, based on the model information received by the server, model data being component information of the watch part;
by the server, generating, based on the event data received by the server, unique data and feature data that are a design element of the watch part;
by the server, transmitting, to the output terminal, the model data, the unique data, and the feature data; and
by the output terminal, displaying the model data, the unique data, and the feature data on a display unit of the output terminal.

2. The design generation method for a watch part according to claim 1, wherein
the unique data and the feature data each include a plurality of elements, and
when the element of the unique data overlaps the element of the feature data, the output terminal or the server deletes the overlapping element of the feature data.

3. The design generation method for a watch part according to claim 1, wherein
the output terminal or the server emphasizes the element that constitutes the unique data over the element of the feature data.

4. The design generation method for a watch part according to claim 1, wherein
the model data includes profile data for a plurality of components that constitute the watch.

5. The design generation method for a watch part according to claim 1, wherein
the model data includes an arrangement restriction region where an arrangement of the unique data and the feature data is restricted.

6. The design generation method for a watch part according to claim 1, wherein
the event data includes a date/time and location information that are specified by the user.

7. The design generation method for a watch part according to claim 6, wherein
the generating of the unique data and the feature data includes generating, by the server, the unique data and the feature data based on the date/time and the location information.

8. The design generation method for a watch part according to claim 1, wherein
the unique data is any of a constellation, a building, or a geographic feature.

9. The design generation method for a watch part according to claim 1, wherein
the feature data is any of a star map, a landscape, or a pattern.

10. The design generation method for a watch part according to claim 1, the method comprising:
by the output terminal, transmitting, to the server, request data instructing an additional design element of the watch part;
by the server, generating additional object data based on the request data;
by the server, transmitting the additional object data to the output terminal; and
by the output terminal, displaying the model data, the unique data, the feature data, and the additional object data on the display unit of the output terminal.

11. A design generation system for a watch part, comprising an output terminal and a server communicating via a network, wherein
the output terminal is configured to
transmit, to the server, watch model information selected by a user and event data entered by the user, and
display, on a display unit, model data, unique data, and feature data that are received from the server, and
the server is configured to
generate, based on the model information received by the server, model data being component information of the watch part,
generate the unique data and the feature data based on the event data received by the server, and
transmit the model data, the unique data, and the feature data to the output terminal.

12. A server comprising:
a communication unit configured to communicate with an output terminal via a network; and
a processing unit configured to
generate model data being component information of a watch part, based on watch model information received from the output terminal,
generate unique data and feature data based on event data received from the output terminal, and
transmit the model data, the unique data, and the feature data to the output terminal.

13. An output terminal comprising:
a communication unit configured to communicate with a server via a network;
an operating unit operated by a user;
a display unit; and
a processing unit,
the processing unit being configured to
transmit, to the server, watch model information selected by a user using the operating unit and event data entered by the user using the operating unit, and
display, on the display unit, model data, unique data, and feature data that are received from the server.
